(19) United States
(12) Patent Application Publication
(10) Pub. No.: US 2022/0247178 A1
(43) Pub. Date: Aug. 4, 2022

(54) UNDEREXCITATION PROTECTION FOR NEARBY CONVENTIONAL POWER PLANTS BY WIND POWER INSTALLATIONS

(71) Applicant: Wobben Properties GmbH, Aurich (DE)

(72) Inventor: Johannes Brombach, Berlin (DE)

(21) Appl. No.: 17/586,438

(22) Filed: Jan. 27, 2022

(30) Foreign Application Priority Data
Jan. 29, 2021 (EP) 21154437.4

(51) Int. Cl. H02J 3/18; H02J 3/38; G05B 15/02

(52) U.S. Cl. CPC H02J 3/18; H02J 2300/28; G05B 15/02; H02J 3/38

(57) ABSTRACT

A method for controlling a wind power installation or a wind farm, comprising the steps: exchanging active and/or reactive electrical power at a grid connection point with an electrical supply grid that has a conventional power plant; ascertaining a reactive power demand of the electrical supply grid; changing the exchange of the reactive electrical power at the grid connection point with the electrical supply grid in dependence on the reactive power demand of the electrical supply grid, in order to support the conventional power plant.

### BACKGROUND

### Technical Field

The present invention relates to a method for controlling a wind power installation and/or a wind farm, and to such a wind power installation and/or such a wind farm.

### Description of the Related Art

Wind power installations, or wind farms, are generally known and are used in particular to generate active electrical power.

The active electrical power is then usually distributed to corresponding consumers by means of an electrical supply grid.

The electrical supply grid usually has a plurality of other electrical generators such as, for example, conventional power plants, and/or electrical consumers such as, for example, blast furnaces.

Conventional power plants such as, for example, coal-fired power plants, usually have a synchronous generator, the operating point of which depends on the state of the electrical supply grid, in particular on the grid voltage and/or the grid frequency.

This dependence, and the fact that synchronous generators have a limited operating range, can result in a synchronous generator of a conventional power plant becoming unstable due to changes in the state of the electrical supply grid.

It can thus happen that the synchronous generator slips into suboptimal or even unstable operating points if, for example, large load switching operations are effected in the electrical supply grid.

Thus, for example, load switching operations can result in an oversupply of reactive power in the electrical supply grid, forcing the synchronous generator into underexcitation, which in turn results in the synchronous generator having suboptimal active power generation or even becoming unstable.

### BRIEF SUMMARY

Improvements to support conventional power plants is provided. Provided is a method for controlling a wind power installation or a wind farm is thus proposed, comprising the steps: exchanging active and/or reactive electrical power at a grid connection point with an electrical supply grid that has a conventional power plant; ascertaining a reactive power demand of the electrical supply grid; changing the exchange of the reactive electrical power at the grid connection point with the electrical supply grid in dependence on the reactive power demand of the electrical supply grid, in order to support the conventional power plant.

There is thus proposed, in particular, an underexcitation protection for nearby conventional power plants, realized by wind power installations.

In particular, conventional power plants are to be supported by means of a wind power installation, or by means of a wind farm, preferably by take-up of reactive power from the electrical supply grid by means of the wind power installation, or by means of the wind farm, in particular in such a way that the conventional power plant, or the synchronous generator of the conventional power plant, does not fall into underexcitation.

The wind power installation, or wind farm, in this case first exchanges active and/or reactive electrical power with the electrical supply grid, as usual. A conventional closed-loop control system, for example, may be used for this purpose, preferably as a lower-order closed-loop control system.

In a next step, it is also ascertained, for example by means of a closed-loop power control system, in particular a higher-order closed-loop power control system, whether the electrical supply grid has a reactive power demand.

The reactive power demand of the electrical supply grid may be determined, for example, by measuring the terminal voltage of the wind farm at the grid connection point.

However, the reactive power demand may also be determined by means of data from the operator of the conventional power plant and/or by means of data from the operator of the electrical supply grid.

The reactive power demand of the electrical supply grid in this case may be inductive (reactive power take-up) or capacitive (reactive power output).

Thus if, for example, the terminal voltage of the wind farm at the grid connection point is low, the electrical supply grid requires reactive electrical power (inductive; reactive power take-up). If the terminal voltage is high, the electrical supply grid has too much reactive electrical power (capacitive; reactive power output).

Preferably, the present method is applied in the lower range of the reactive power take-up of the electrical supply grid and/or in the case of reactive power output of the electrical supply grid. This is shown, for example, in FIG. 5.

If a reactive power demand on the part of the electrical supply grid has been ascertained, the reactive electrical power of the wind power installation, or wind farm, is changed in dependence on the ascertained reactive power demand in such a way that the conventional power plant is supported, in particular in such a way that the synchronous generator of the conventional power plant is in an overexcited state.

It is thus also proposed, in particular, to use a wind power installation to cover the reactive power demand of the electrical supply grid that cannot be provided by the conventional power plant.

Optionally, the electrical supply grid in this case is in a normal, or fault-free, operating state.

It is thus also proposed, in particular, to execute the method during normal operation of the electrical supply grid, in particular in order to compensate the effects of load switching operations within the electrical supply grid, by means of wind power installations. Normal operation of the electrical supply grid is understood herein to mean, in particular, all operating states up to load shedding, thus for example between 47.5 Hertz (Hz) and 52.5 Hz in the case of an electrical supply grid having a nominal grid frequency of 50 Hz. In particular, this is therefore an undisturbed operating mode, i.e., in particular not black-out and/or isolated grid operation.

Preferably, the conventional power plant is also realized as a grid former and/or has at least one, preferably directly coupled, synchronous generator.

A grid former in this case is understood to be, in particular, the generator that specifies the frequency for the electrical supply grid, or a section of the electrical supply grid. In this case, the conventional power plant.

The conventional power plant in this case may be, for example, a (hard-)coal or nuclear power plant.

Preferably, the wind power installation, or wind farm, is located in the electrical proximity of the conventional power plant, in particular in such a way that the exchange of the reactive power of the wind power installation, or wind farm, affects the conventional power plant.

Electrical proximity is understood herein to mean, in particular, the electrical line distance. Preferably, this electrical line distance is less than 100 kilometers (km), more preferably less than 50 km.

Preferably, the changing of the exchange of the reactive electrical power is effected only up to a predefined reactive-power limit value.

It is thus also proposed, in particular, to execute the method only in a defined operating range of the electrical supply grid, in particular when the electrical supply grid operates capacitively. Thus, in the cases in which there is a risk of the synchronous generator of the conventional power plant slipping into underexcitation.

Preferably, the reactive-power limit value is selected, in particular taking into account a grid load, such that a synchronous generator of the conventional power plant has an overexcited state.

It is thus proposed, in particular, to use the reactive-power control range of wind power installations and wind farms to protect conventional power plants from underexcitation.

For this purpose it is proposed, in particular, to take the grid load into account.

Grid load in this case is understood to mean, in particular, the load on the operating resources of the electrical supply grid, i.e., the load on the lines, transformers and so forth.

Preferably, this overexcited state has a minimum separation from an underexcited state.

It is thus also proposed, in particular, to select the reactive-power limit value in such a manner that there is a margin of safety with respect to the underexcited state in the conventional power plant.

The reactive-power limit value is thus deliberately selected such that the method is already executed when the conventional power plant is still in the overexcited state. Preferably, the reactive power demand is determined in dependence on a grid load of the electrical supply grid.

It is thus also proposed, in particular, to determine the reactive power demand of the electrical supply grid taking into account the grid load.

The grid load may be determined, for example, by statistical analyses and/or indices from the grid operator, for example load-flow studies, statistical grid analyses or local measurements, for example at the grid connection points of (large) power plants and/or wind farms.

Also proposed is a wind power installation and/or a wind farm, having: a controller, comprising a lower-order closed-loop control system for identifying an active and/or reactive electrical power to be exchanged with the electrical supply grid, and a higher-order closed-loop control system for identifying a reactive power to be exchanged with the electrical supply grid, wherein the reactive power to be exchanged is determined in dependence on a reactive power demand of the electrical supply grid in such a way that a neighboring conventional power station is supported.

Preferably, the controller is further configured to execute a method described above and/or below.

### BRIEF DESCRIPTION OF THE SEVERAL VIEWS OF THE DRAWINGS

The present invention is now explained in greater detail below by way of example and on the basis of exemplary embodiments, and with reference to the accompanying figures, with assemblies that are the same or similar being denoted by the same references.

FIG. 1 shows a schematic view of a wind power installation, according to one embodiment.

FIG. 2 shows a schematic view of an electrical supply grid, according to one embodiment.

FIG. 3 shows a schematic sequence of a method for controlling, in one embodiment.

FIG. 4 shows, in schematic form, the operating ranges of a conventional power plant and of a wind power installation, according to one embodiment.

FIG. 5 shows, in schematic form, a technical effect of the method for controlling, according to one embodiment.

### DETAILED DESCRIPTION

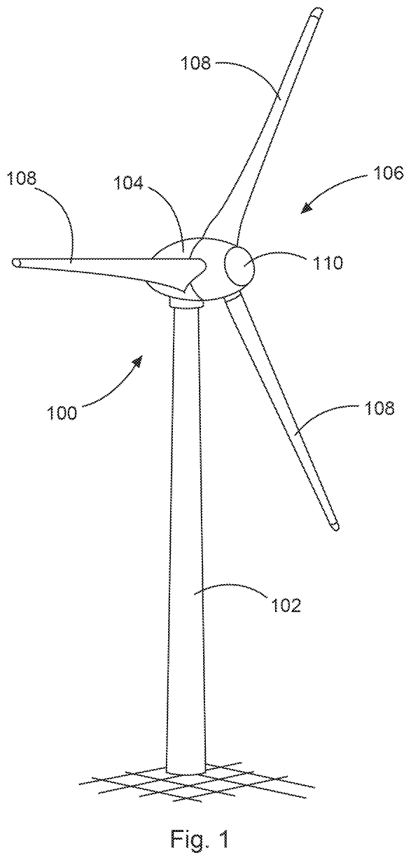

FIG. 1 shows a schematic view of a wind power installation 100 according to one embodiment.

The wind power installation 100 has a tower 102 and a nacelle 104.

Arranged on the nacelle 104 there is an aerodynamic rotor 106 that has three rotor blades 108 and a spinner 110.

When in operation, the aerodynamic rotor 106 is made to rotate by the wind, and thereby drives a generator in the nacelle 104.

A controller, described above and/or below, is also provided for operating the wind power installation, in particular in order to execute a method, described above and/or below, for controlling a wind power installation, and/or in order to participate in a method, described above and/or below, for controlling a wind farm.

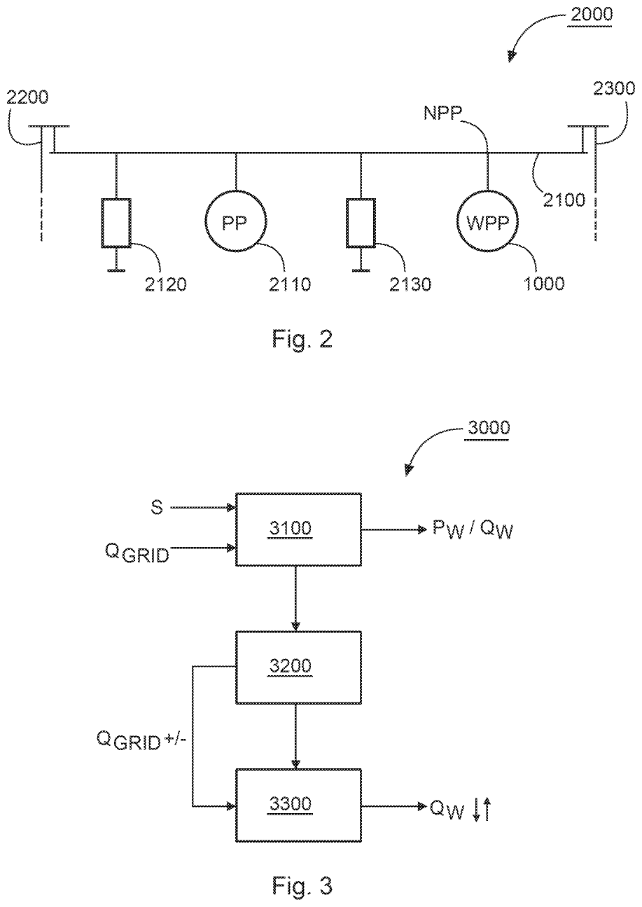

FIG. 2 shows a schematic view of an electrical supply grid, according to one embodiment.

The electrical supply grid 2000 comprises, for example, three grid levels 2100, 2200, 2300.

The grid level 2100 has, for example, a conventional power plant 2110, a plurality of consumers 2120, 2130, and a wind farm 1000, described above and/or below.

The wind farm 1000 is connected to the electrical supply grid 2000 at a grid connection point NPP and is arranged in the electrical proximity, for example at a line length distance of 40 km, of the conventional power plant 2110, and comprises a controller that is configured to execute a method, described above and/or below, for controlling a wind farm.

FIG. 3 shows a schematic sequence of a method 3000 for controlling a wind power installation, in particular as shown in FIG. 1, or a wind farm, in particular as shown in FIG. 2.

In a first step 3100, active electrical power P_{w} and/or reactive electrical power Q_{w} is exchanged with an electrical supply grid at a grid connection point NPP.

The exchange of the active electrical power P_{w} and/or reactive electrical power Q_{w} is controlled by closed-loop control, for example by means of a lower-order closed-loop control system of the controller, which works with setpoint values S.

During this exchange, the reactive power demand Q_{g}nd of the electrical supply grid 2000 is monitored, for example, at the grid connection point.

In a next step 3200, it is ascertained that the electrical supply grid 2000 has a reactive power demand Q_{grid}. This reactive power demand Q_{g}nd may be capacitive Q_{grid+} or inductive Q_{grid-}.

In a next step 3300, the exchange of the electrical reactive power Q_{w} is then changed, in particular in dependence on the reactive power demand Q_{grid}, such that a neighboring conventional power plant, as shown in FIG. 2, for example, is supported.

It is thus proposed in particular that the wind farm, or wind power plant, take up excess reactive power from the electrical supply grid in order to support the conventional power plant.

The method in this case is particularly well suited to protecting a synchronous generator of a conventional power plant from underexcitation.

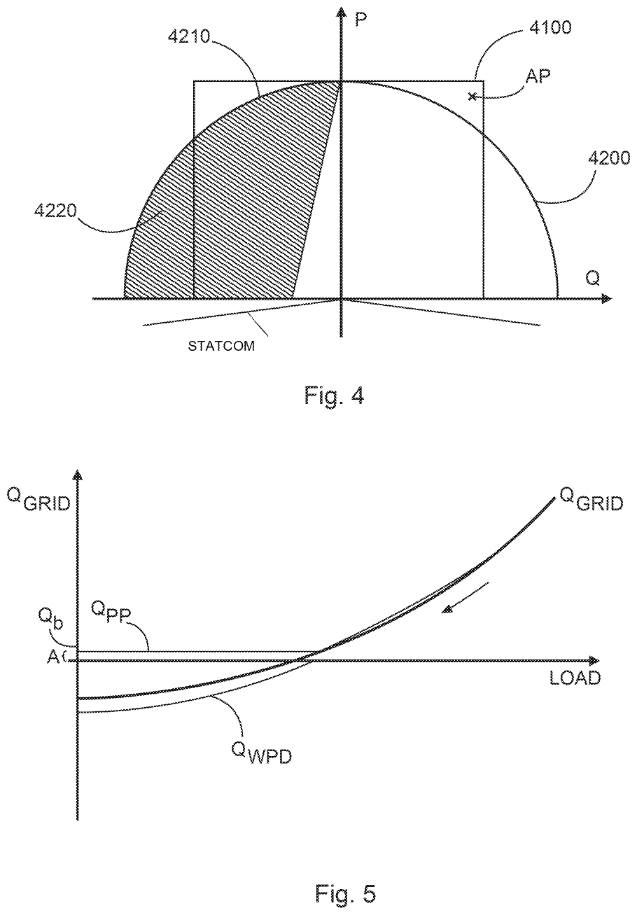

FIG. 4 shows, in schematic form, the operating ranges of a conventional power plant and of a wind power installation.

The operating ranges are plotted in active and reactive power quadrants P/Q.

The wind power installation has a full converter that has a wide active and reactive power adjustment range. This is indicated by the substantially quadrangular operating range 4100. The wind power installation in this case is able in particular to assume any discretionary operating point AP, for example full active power in the case of zero reactive power or full reactive power in the case of zero active power.

The conventional power plant has a synchronous generator that has a limited active and reactive power adjustment range. This is indicated by the substantially semicircular operating range 4200. In particular, the synchronous generator in this case is not able to achieve any discretionary operating point AP or to operate in a stable manner.

The synchronous generator also has underexcitation operating sub-ranges 4210, 4220.

In the highly underexcited operating sub-range 4220, the synchronous generator can become unstable.

The synchronous generator can fall into this operating range 4220, for example, if there is significant load shedding in the electrical supply grid.

To prevent this, it is proposed to use a wind power installation or a wind farm for support.

Thus, for example, if the voltage in the electrical supply grid surges due to load shedding, the wind power installation, or wind farm, can actively lower the voltage for several minutes and thus prevent the synchronous generator of the conventional power plant from falling into an unstable operating range.

FIG. 5 shows, in schematic form, a technical effect 5000 of the method for controlling, according to one embodiment.

The technical effect 5000 occurs, in particular, with respect to the reactive power demand of the electrical supply grid 2000 if the grid load is taken into account for control.

For this purpose, by way of example, the reactive power demand Q_{grid} of the electrical supply grid is plotted against the grid load.

If the grid load LOAD drops, the reactive power demand Q_{grid} of the electrical supply grid also decreases.

The grid load LOAD in this case can drop to such an extent that the electrical supply grid, and thus also the synchronous generator of the conventional power plant, falls into underexcitation.

This can be prevented, for example, by means of a wind farm, for example as described above.

In a preferred embodiment, a reactive-power limit value Q_{g} is also used. This reactive-power limit value Q_{g} is preferably selected with a separation A from the underexcitation.

If the reactive power demand Q_{grid} of the electrical supply grid falls below this reactive-power limit value Q_{g}, the wind power installation, or wind farm, takes up corresponding reactive power in order to support the conventional power plant.

It is thus also proposed that the wind power installation, or wind farm, intervene deliberately and at an early stage in the reactive power demand of the electrical supply grid.

### LIST OF REFERENCES

100 wind power installation
102 tower, in particular of the wind power installation
104 nacelle, in particular of the wind power installation
106 aerodynamic rotor, in particular of the wind power installation
108 rotor blade, in particular of the wind power installation
110 spinner, in particular of the wind power installation
1000 wind farm, in particular comprising a plurality of wind power installations
2000 electrical supply grid
2100 grid level, in particular of the electrical supply grid
2110 conventional power plant
2120 consumer
2130 consumer
2200 grid level, in particular of the electrical supply grid
2300 grid level, in particular of the electrical supply grid
3000 method for controlling a wind power installation or a wind farm
3100 method step: exchanging
3200 method step: ascertaining
3300 method step: changing
4000 operating ranges
4100 operating range of a wind power installation
4200 operating range of a conventional power plant
4210 operating sub-range
4220 operating sub-range
5000 technical effect
A separation, in particular with respect to underexcitation
AP operating point
LOAD grid load
P_{w} active power exchanged with the electrical supply grid
Q_{w} reactive power exchanged with the electrical supply grid
Q_{grid} reactive power demand, in particular of the electrical supply grid
Q_{g} reactive-power limit value
S setpoint values, in particular for the wind power installation, or the wind farm
PP conventional power plant
NPP grid connection point
WPP wind farm

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling a wind power installation or a wind farm, the method comprising:
exchanging active and/or reactive electrical power at a grid connection point with an electrical supply grid, wherein a conventional power plant is coupled to the electrical supply grid;
ascertaining a reactive power demand of the electrical supply grid; and
changing the exchange of the reactive electrical power at the grid connection point with the electrical supply grid in dependence on the reactive power demand of the electrical supply grid, in order to support the conventional power plant.

2. The method for controlling a wind power installation or a wind farm as claimed in claim 1, wherein the electrical supply grid is in a fault-free operating state.

3. The method for controlling a wind power installation or a wind farm as claimed in claim 1, wherein the conventional power plant is a grid former and/or has a synchronous generator.

4. The method for controlling a wind power installation or a wind farm as claimed in claim 1, wherein the wind power installation or wind farm is located in an electrical proximity of the conventional power plant.

5. The method for controlling a wind power installation or a wind farm as claimed in claim 1, wherein the changing the exchange of the reactive electrical power is effected up to a predefined reactive-power limit value.

6. The method for controlling a wind power installation or a wind farm as claimed in claim 5, wherein the predefined reactive-power limit value is selected taking into account a grid load, such that a synchronous generator of the conventional power plant has an overexcited state.

7. The method for controlling a wind power installation or a wind farm as claimed in claim 6, wherein the overexcited state has a minimum separation from an underexcited state.

8. The method for controlling a wind power installation or a wind farm as claimed in claim 1, wherein the reactive power demand is determined in dependence on a grid load of the electrical supply grid.

9. The method for controlling a wind power installation or a wind farm as claimed in claim 8, wherein the grid load is determined by statistical analyses.

10. A wind power installation or wind farm, comprising:
a controller, comprising:
a lower-order closed-loop for identifying an active and/or a reactive electrical power to be exchanged with the electrical supply grid; and
a higher-order closed-loop for identifying a reactive power to be exchanged with the electrical supply grid, wherein the higher-order closed-loop has a higher order than the lower-order closed-loop, wherein the reactive power to be exchanged is determined in dependence on a reactive power demand of the electrical supply grid in such a way that a neighboring conventional power station is supported.

11. The wind power installation or wind farm as claimed in claim 10, wherein the controller is configured to execute a method.
